(19) United States
(12) Patent Application Publication
(10) Pub. No.: US 2024/0312693 A1
(43) Pub. Date: Sep. 19, 2024

(54) INDUCTOR AND MANUFACTURING METHOD THEREOF, FILTER AND ELECTRONIC DEVICE

(71) Applicants: BEIJING BOE OPTOELECTRONICS TECHNOLOGY CO., LTD., Beijing (CN); BOE TECHNOLOGY GROUP CO., LTD., Beijing (CN)

(72) Inventors: Yulin FENG, Beijing (CN); Yue LI, Beijing (CN); Yuelei XIAO, Beijing (CN); Xue CAO, Beijing (CN); Kidong HAN, Beijing (CN); Lihui WANG, Beijing (CN); Qiuxu WEI, Beijing (CN); Wenbo CHANG, Beijing (CN); Yifan WU, Beijing (CN); Yi ZHOU, Beijing (CN); Qichang AN, Beijing (CN); Yanfei REN, Beijing (CN); Huiying LI, Beijing (CN); Biqi LI, Beijing (CN)

(21) Appl. No.: 18/027,920

(22) PCT Filed: Jun. 29, 2022
(86) PCT No.: PCT/CN2022/102219

§ 371 Date: Mar. 22, 2023

(51) Int. Cl. H01F 27/28; H01F 27/29; H01F 27/32; H01F 41/00

(52) U.S. Cl. CPC H01F 27/2852; H01F 27/29; H01F 27/32; H01F 41/00

(57) ABSTRACT

An inductor, a manufacturing method for an inductor, a filter and an electronic device are provided, and belongs to the field of electronic device technology. The inductor includes: a first dielectric substrate including opposite first and second surfaces along a thickness direction of the first dielectric substrate, wherein the first dielectric substrate is provided with first connection vias penetrating through the first dielectric substrate along the thickness direction, and a first groove penetrating through a part of the first dielectric substrate in the thickness direction; first sub-structures on the first surface; second sub-structures on the second surface; first connection electrodes in the first connection vias, wherein the first and second sub-structures are sequentially connected together through the first connection electrodes to form a coil structure of the inductor; and a magnetic core in the first groove to be insulated from the first and second sub-structures and in the coil structure.

### TECHNICAL FIELD

The present disclosure relates to the field of electronic device technology, and in particular to an inductor, a manufacturing method for an inductor, a filter and an electronic device.

### BACKGROUND

With the rapid development of microelectronic process technology, sizes of various electronic devices are rapidly reduced. As the sizes of the devices are reduced, new technology such as IPD technology, MEMS technology, nanotechnology, etc. is emerging continuously. The improvement of the process also promotes the progress of the device design, a design size of an electronic structure is smaller and smaller, and a chip size, a trace interconnection and a packaging structure are continuously developing. Therefore, various (such as common mobile terminals, notebooks, and the like) in industry and daily life are pursuing miniaturization. Therefore, the miniaturization of the devices is an inevitable trend. The sizes of the devices are developing from the macroscopic meter and centimeter orders to the microscopic micrometer and nanometer orders.

Passive devices are essential basic components in various types of apparatus, and include resistors, capacitors, and inductors. A common inductor is formed by winding a plurality of circles of wires on a ring magnet, and the performance of the inductor is greatly improved through the action of a magnetic core. However, as the size of the device decreases, a planar spiral inductor with a smaller size gradually becomes a common type, a size of a coil decreases to the millimeter or micron order. Due to the winding characteristics of the spiral wire, the coil of the inductor occupies a larger area without the magnetic core; meanwhile, when the inductor is combined with other devices for use, a length of traces is large, and the mutual inductance among the traces is obvious.

### SUMMARY

The present disclosure aims to solve at least one technical problem in the prior art, and provides an inductor, a manufacturing method for an inductor, a filter and an electronic device.

The embodiment of the present disclosure provides an inductor, including: a first dielectric substrate including a first surface and a second surface opposite to each other along a thickness direction of the first dielectric substrate, wherein the first dielectric substrate is provided with first connection vias penetrating through the first dielectric substrate along the thickness direction of the first dielectric substrate, and a first groove penetrating through a part of the first dielectric substrate in the thickness direction of the first dielectric substrate; first sub-structures on the first surface; second sub-structures on the second surface: first connection electrodes in the first connection vias, wherein the first sub-structures and the second sub-structures are sequentially connected together through the first connection electrodes to form a coil structure of the inductor; and a magnetic core arranged in the first groove and insulated from the first sub-structures and the second sub-structures to be in the coil structure.

In some embodiments, the first groove is a blind groove, the magnetic core fills the first groove, a first interlayer insulating layer is provided on the first surface, the first interlayer insulating layer is provided with second connection vias, corresponding to the first connection vias, therein, and the first sub-structures are electrically connected to the first connection electrodes through the second connection vias, respectively.

In some embodiments, the first groove is a blind groove, and a surface of the magnetic core away from the second sub-structures is spaced apart from the first surface; and a first interlayer insulating layer is provided in the first groove and covers the surface of the magnetic core away from the second sub-structures.

In some embodiments, a surface of the first interlayer insulating layer away from the magnetic core is flush with the first surface.

In some embodiments, the first groove is a through groove, the magnetic core fills the first groove; a first interlayer insulating layer is provided on the first surface, and a second interlayer insulating layer is provided on the second surface; the first interlayer insulating layer is provided with second connection vias corresponding to the first connection vias therein, and the second interlayer insulating layer is provided with third connection vias corresponding to the first connection vias therein: the first sub-structures are electrically connected to the first connection electrodes through the second connection vias, respectively; and the second sub-structures are electrically connected to the first connection electrodes through the third connection vias, respectively.

In some embodiments, the first dielectric substrate includes a first dielectric sub-substrate and a second dielectric sub-substrate which are stacked together: a surface of the first dielectric sub-substrate away from the second dielectric sub-substrate is used as the first surface, and a surface of the second dielectric sub-substrate away from the first dielectric sub-substrate is used as the second surface; and the first connection vias include first connection sub-vias in the first dielectric sub-substrate and second connection sub-vias in the second dielectric sub-substrate; the first groove includes a first sub-groove in the first dielectric sub-substrate and a second sub-groove in the second dielectric sub-substrate: the first sub-groove and the second sub-groove are both blind grooves, and an opening of the first sub-groove is opposite to and communicated with an opening of the second sub-groove; the magnetic core includes a first portion filling the first sub-groove and a second portion filling the second sub-groove, and the first portion and the second portion are in contact with each other.

In some embodiments, the first dielectric substrate includes a first dielectric sub-substrate and a second dielectric sub-substrate which are stacked together: a surface of the first dielectric sub-substrate away from the second dielectric sub-substrate is used as the first surface, and a surface of the second dielectric sub-substrate away from the first dielectric sub-substrate is used as the second surface; and the first connection vias include first connection sub-vias in the first dielectric sub-substrate and second connection sub-vias in the second dielectric sub-substrate, the first groove includes a first sub-groove in the first dielectric sub-substrate and a second sub-groove in the second dielectric sub-substrate; the first sub-groove and the second sub-groove are both blind grooves, and an opening of the first sub-groove is opposite to and communicated with an opening of the second sub-groove; the magnetic core includes a first portion in the first sub-groove and a second portion in the second sub-groove, and a third interlayer insulating layer is provided between the first portion and the second portion.

In some embodiments, the first dielectric substrate includes a first dielectric sub-substrate and a second dielectric sub-substrate which are stacked: the first connection vias include first connection sub-vias in the first dielectric sub-substrate and second connection sub-vias in the second dielectric sub-substrate: the first groove includes a first sub-groove in the first dielectric sub-substrate and a second sub-groove in the second dielectric sub-substrate; the first sub-groove and the second sub-groove are both through grooves, and the first sub-groove and the second sub-groove are opposite to and communicated with each other: the magnetic core includes a first portion filling the first sub-groove and a second portion filling the second sub-groove, and the first portion and the second portion are in contact with each other: a surface of the first dielectric sub-substrate away from the second dielectric sub-substrate is used as the first surface, and a surface of the second dielectric sub-substrate away from the first dielectric sub-substrate is used as the second surface; and a first interlayer insulating layer is provided on the first surface, and a second interlayer insulating layer is provided on the second surface: the first interlayer insulating layer is provided with second connection vias corresponding to the first connection vias therein, and the second interlayer insulating layer is provided with third connection vias corresponding to the first connection vias therein; the first sub-structures are electrically connected to the first connection electrodes through the second connection vias: the second sub-structures are electrically connected to the first connection electrodes through the third connection vias.

In some embodiments, a first protective layer is provided on a side of the first sub-structures away from the first dielectric substrate.

In some embodiments, a first protective layer is provided on a side of the second sub-structures away from the first dielectric substrate.

In some embodiments, the first groove is a blind groove and an opening of the first groove is away from the first sub-structures: the inductor further includes a second dielectric substrate: the second sub-structures are on the second dielectric substrate, a fourth interlayer insulating layer is provided on a side of the second sub-structures away from the second dielectric substrate, fourth connection vias are provided in the fourth interlayer insulating layer and corresponds to the first connection vias, and the second sub-structures are electrically connected to the first connection electrodes through the fourth connection vias.

In some embodiments, the first groove is a blind groove and an opening of the first groove is away from the first sub-structures; the inductor further includes a second dielectric substrate: the second sub-structures are on the second dielectric substrate, a fourth interlayer insulating layer is provided on a side of the second sub-structures away from the second dielectric substrate, fourth connection vias are provided in the fourth interlayer insulating layer and corresponds to the first connection vias, and the second sub-structures are electrically connected to the first connection electrodes through the fourth connection vias; and a fifth insulating layer is provided in the first groove and on a side of the magnetic core away from the first sub-structures; and a surface of the fifth insulating layer away from the magnetic core is flush with the second surface.

In some embodiments, the first groove is a through groove, the magnetic core fills the first groove: a first interlayer insulating layer is provided on the first surface; the first interlayer insulating layer is provided with second connection vias corresponding to the first connection vias therein; and the first sub-structures are electrically connected to the first connection electrodes through the second connection vias; and the inductor further includes a second dielectric substrate: the second sub-structures are on the second dielectric substrate, a fourth interlayer insulating layer is provided on a side of the second sub-structures away from the second dielectric substrate, fourth connection vias are provided in the fourth interlayer insulating layer and corresponds to the first connection vias, and the second sub-structures are electrically connected to the first connection electrodes through the fourth connection vias;

In some embodiments, adapter electrodes are provided within the fourth connection vias, and the second sub-structures are electrically connected to the first connection electrodes through the adapter electrodes.

In some embodiments, a first protective layer is provided on a side of the first sub-structures away from the first dielectric substrate.

The embodiment of the present disclosure provides a method for manufacturing an inductor, including: providing a first dielectric substrate, wherein the first dielectric substrate includes a first surface and a second surface opposite to each other along a thickness direction of the first dielectric substrate, the first dielectric substrate is provided with first connection vias penetrating through the first dielectric substrate along the thickness direction of the first dielectric substrate, and a first groove penetrating through a part of the first dielectric substrate in the thickness direction of the first dielectric substrate; and forming first sub-structures on the first surface; forming second sub-structures on the second surface: forming first connection electrodes in the first connection vias, forming a magnetic core in the first groove; wherein the first sub-structures and the second sub-structures are sequentially connected together through the first connection electrodes to form a coil structure of the inductor; and the magnetic core is insulated from the first sub-structures and the second sub-structures to be in the coil structure.

In some embodiments, the first groove is a blind groove, and an opening of the first groove is opposite to the first sub-structures: before the forming the first sub-structures on the first surface, the method further includes: forming a first interlayer insulating layer on the first surface, to insulate the magnetic core from the first sub-structures.

In some embodiments, the first groove is a through groove: before the forming the first sub-structures on the first surface, the method further includes: forming a first interlayer insulating layer on the first surface, to insulate the magnetic core from the first sub-structures; and after the forming the second sub-structures on the second surface, the method further includes: forming a second interlayer insulating layer on the second surface, to insulate the magnetic core and the second sub-structures.

In some embodiments, the first dielectric substrate includes a first dielectric sub-substrate and a second dielectric sub-substrate which are stacked; the first connection vias include first connection sub-vias formed in the first dielectric sub-substrate and second connection sub-vias formed in the second dielectric sub-substrate; the first groove includes a first sub-groove formed in the first dielectric sub-substrate and a second sub-groove formed in the second dielectric sub-substrate; the first sub-groove and the second sub-groove are both blind grooves, and the first sub-groove and the second sub-groove are opposite to and communicated with each other, a surface of the first dielectric sub-substrate away from the second dielectric sub-substrate is used as the first surface, and a surface of the second dielectric sub-substrate away from the first dielectric sub-substrate is used as the second surface; the forming the magnetic core includes: forming a first portion of the magnetic core in the first sub-groove, and forming a second portion of the magnetic core in the second sub-groove, wherein the first portion fills the first sub-groove; and the method further includes: forming a third insulating layer between the first and second portions.

In some embodiments, the first dielectric substrate includes a first dielectric sub-substrate and a second dielectric sub-substrate which are stacked: the first connection vias include first connection sub-vias formed in the first dielectric sub-substrate and second connection sub-vias formed in the second dielectric sub-substrate; the first groove includes a first sub-groove formed in the first dielectric sub-substrate and a second sub-groove formed in the second dielectric sub-substrate; the first sub-groove and the second sub-groove are both through grooves, and the first sub-groove and the second sub-groove are opposite to and communicated with each other: a surface of the first dielectric sub-substrate away from the second dielectric sub-substrate is used as the first surface, and a surface of the second dielectric sub-substrate away from the first dielectric sub-substrate is used as the second surface; the forming the magnetic core includes: forming a first portion of the magnetic core in the first sub-groove, and forming a second portion of the magnetic core in the second sub-groove, wherein the first portion fills the first sub-groove and the first portion and the second portion are in contact with each other; after the forming the first sub-structures, the method further includes: forming a first interlayer insulating layer on the first surface, to insulate the magnetic core from the first sub-structures; and after the forming the second sub-structures on the second surface, the method further includes: forming a second interlayer insulating layer on the second surface, to insulate the magnetic core and the second sub-structures.

The embodiment of the present disclosure provides a filter, which includes the inductor any one of the above embodiments.

In some embodiments, the filter further includes a capacitor electrically connected to the inductor, wherein a first plate of the capacitor and the first sub-structures of the inductor are connected together to form a one-piece structure.

The embodiment of the present disclosure provides an electronic device, which includes the above filter.

### BRIEF DESCRIPTION OF DRAWINGS

FIG. 1 is a top view of an inductor according to an embodiment of the present disclosure.

FIG. 2 is a perspective view of an inductor according to an embodiment of the present disclosure.

FIG. 3 is a cross-sectional view of an inductor according to a first example of an embodiment of the present disclosure.

FIG. 4 is a cross-sectional view of an intermediate product formed in step S11 of a method for manufacturing an inductor according to a first example of an embodiment of the present disclosure.

FIG. 5 is a cross-sectional view of an intermediate product formed in step S12 of a method for manufacturing an inductor according to a first example of an embodiment of the present disclosure.

FIG. 6 is a cross-sectional view of an intermediate product formed in step S13 of a method for manufacturing an inductor according to a first example of an embodiment of the present disclosure.

FIG. 7 is a cross-sectional view of an intermediate product formed in step S14 of a method for manufacturing an inductor according to a first example of an embodiment of the present disclosure.

FIG. 8 is a cross-sectional view of an intermediate product formed in step S15 of a method for manufacturing an inductor according to a first example of an embodiment of the present disclosure.

FIG. 9 is a cross-sectional view of an intermediate product formed in step S16 of a method for manufacturing an inductor according to a first example of an embodiment of the present disclosure.

FIG. 10 is a cross-sectional view of an intermediate product formed in step S17 of a method for manufacturing an inductor according to a first example of an embodiment of the present disclosure.

FIG. 11 is a cross-sectional view of an inductor according to a second example of an embodiment of the present disclosure.

FIG. 12 is a cross-sectional view of an inductor according to a third example of an embodiment of the present disclosure.

FIG. 13 is a cross-sectional view of an inductor according to a fourth example of an embodiment of the present disclosure.

FIG. 14 is a cross-sectional view of an inductor according to a fifth example of an embodiment of the present disclosure.

FIG. 15 is a cross-sectional view of an inductor according to a sixth example of an embodiment of the present disclosure.

FIG. 16 is a cross-sectional view of an inductor according to a seventh example of an embodiment of the present disclosure.

FIG. 17 is a cross-sectional view of an inductor according to an eighth example of an embodiment of the present disclosure.

FIG. 18 is a cross-sectional view of an inductor according to a ninth example of an embodiment of the present disclosure.

### DETAIL DESCRIPTION OF EMBODIMENTS

In order to enable one of ordinary skill in the art to better understand the technical solutions of the present disclosure, the present invention will be described in further detail with reference to the accompanying drawings and the detailed description.

Unless defined otherwise, technical or scientific terms used herein shall have the ordinary meaning as understood by one of ordinary skill in the art to which the present disclosure belongs. The terms “first”, “second”, and the like used in the present disclosure are not intended to indicate any order, quantity, or importance, but rather are used for distinguishing one element from another. Further, the term “a”. “an”. “the”, or the like used herein does not denote a limitation of quantity, but rather denotes the presence of at least one element. The term of “comprising”. “including”, or the like, means that the element or item preceding the term contains the element or item listed after the term and its equivalent, but does not exclude other elements or items. The term “connected”, “coupled”, or the like is not limited to physical or mechanical connections, but may include electrical connections, whether direct or indirect connections. The terms “upper”. “lower”, “left”. “right”, and the like are used only for indicating relative positional relationships, and when the absolute position of an object being described is changed, the relative positional relationships may also be changed accordingly.

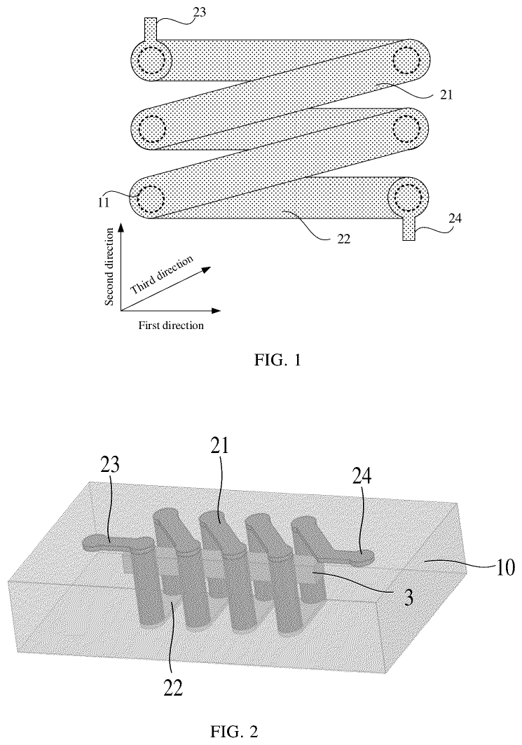

FIG. 1 is a top view of an inductor according to an embodiment of the present disclosure. Referring to FIG. 1, the inductor includes first sub-structures 21 extending along a first direction and arranged side by side along a second direction; second sub-structures 22 extending in a third direction and arranged side by side in the second direction. The first direction, the second direction and the third direction are different from each other. In the embodiment of the present disclosure, as an example, the first direction and the second direction are perpendicular to each other, and the first direction and the third direction intersect with each other and are non-perpendicular to each other for description. Alternatively, the extending directions of the first sub-structures 21 and the second sub-structures 22 may be interchanged with each other, which is also within the protection scope of the embodiments of the present disclosure. In addition, in the present embodiment, as an example, the inductor includes N first sub-structures 21 and N−1 second sub-structures 22 for description, where N≥2, and N is an integer. Orthographic projections of a first terminal and a second terminal of each first sub-structure 21 on the first dielectric substrate 10 at least partially overlap with orthographic projections of two first connection vias 11 on the first dielectric substrate 10, respectively. The first terminal and the second terminal of each first sub-structure 21 correspond to two different first connection vias 11. That is, an orthographic projection of each first sub-structure 21 on the first dielectric substrate at least partially overlap with the orthographic projections of two first connection vias 11 on the first dielectric substrate. At this time, a first terminal of the ith second sub-structure 22 of the inductor is connected to the first terminal of the ith first sub-structure 21 and the second terminal of the (i+1)th first sub-structure 21 to form a coil structure of an inductor, where 1≤i≤N−1, and i is an integer.

It should be noted that a first lead terminal 24 is connected to a second terminal of the 1st first sub-structure 21 of the inductor coil, and a second lead terminal 23 is connected to a first terminal of the Nth first sub-structure 21. Further, the first lead terminal 24 and the second lead terminal 23 and the second sub-structures 22 may be disposed in the same layer and made of the same material. At this time, the first lead terminal 24 may be connected to the second terminal of the 1st first sub-structure 21 through a first connection via 11, and correspondingly, the second lead terminal 23 may be connected to the first terminal of the Nth first sub-structure 21 through a first connection via 11.

FIG. 2 is a perspective view of an inductor according to an embodiment of the present disclosure. As shown in FIG. 2, the inductor according to the embodiment of the present disclosure includes not only the above structures, but also a magnetic core 3 integrated on the first dielectric substrate 10, and penetrating through the coil structure of the inductor. The magnetic core 3 is provided in the inductor in the embodiment of the present disclosure, so that an inductance value of the inductor is multiplied, a packaging volume of the device is reduced, the miniaturization development of the device is facilitated, and the cost of manufacturing the device is reduced.

Specifically, the inductance is calculated according to the following formula:

$$L = {μ}_{0} {μ}_{r} {KN}^{2} A / l$$

where μ₀ is a vacuum permeability and μᵣ is a material permeability, K is NAGAOKA coefficient. N is the number of winding turns, A is a cross-sectional area of the coil, and 1 is a length of the coil. According to the formula, with the same structure of the inductor, if the magnetic core 3 is added into the inductor, the inductance is multiplied according to the permeability. A material of the first dielectric substrate 10 may be selected from non-ferromagnetic materials with the permeability close to the vacuum permeability, such as silicon, ceramics, glass, etc. If ferromagnetic materials such as iron, cobalt, nickel, etc. and alloys are added as a material of the magnetic core 3 with the permeability of much greater than 1000, so that the inductance value per unit area is improved, and the wider use of devices and the miniaturization application of packaging are facilitated.

An inductor and a method for manufacturing the inductor in the embodiments of the present disclosure are described by the following specific examples.

In a first example, FIG. 3 is a cross-sectional view of an inductor according to a first example of an embodiment of the present disclosure. As shown in FIG. 3, the inductor includes a first dielectric substrate 10, first sub-structures 21, second sub-structures 22, a magnetic core 3, first connection electrodes, and a first interlayer insulating layer 41. The first dielectric substrate 10 of the inductor includes a first surface (upper surface) and a second surface (lower surface) which are oppositely arranged along a thickness direction of the first dielectric substrate 10, the first dielectric substrate 10 of the inductor is provided with first connection vias 11 penetrating through the first dielectric substrate 10 along the thickness direction of the first dielectric substrate 10, and a first groove 12 penetrating through a part of the first dielectric substrate 10 in the thickness direction of the first dielectric substrate 10, the first groove 12 is a blind groove, and the opening of the first groove 12 is towards a direction away from the second surface. The first sub-structures 21 are arranged on the first surface of the first dielectric substrate 10 and the second sub-structures 22 are arranged on the second surface of the first dielectric substrate 10. Each first connection electrode 25 is arranged in the corresponding first connection via 11 and the magnetic core 3 is arranged in the first groove 12 and fills the first groove 12, i.e., the opening of the first groove 12 away from the second surface is flush with the first surface. The first interlayer insulating layer is provided on the first surface and is configured to separate the first sub-structures 21 and the magnetic core 3, thereby preventing the first sub-structures 21 and the magnetic core 3 from being short-circuited together. The first insulating layer is provided with second connection vias, the second connection vias are in one-to-one correspondence with the first connection vias 11, and the second sub-structures 22 are connected to the first connection electrodes 25 through the second connection vias, so that the first sub-structures 21 and the second sub-structures 22 are sequentially connected to each other through the first connection electrodes 25 to form the coil structure of the inductor, and the magnetic core 3 is limited in the coil structure.

Furthermore, a first protective layer 51 is further disposed on a side of the first sub-structures 21 away from the first dielectric substrate 10, and a second protective layer 52 is further disposed on a side of the second sub-structures 22 away from the first dielectric substrate 10. The first protective layer 51 and the second protective layer 52 are respectively used to isolate the first sub-structures 21 and the second sub-structures 22 from external water and oxygen, thereby avoiding the damage to the device.

The materials and thicknesses of the layers of the inductor in this example are described in conjunction with the following manufacturing method.

The method for manufacturing the inductor may specifically include the following steps.

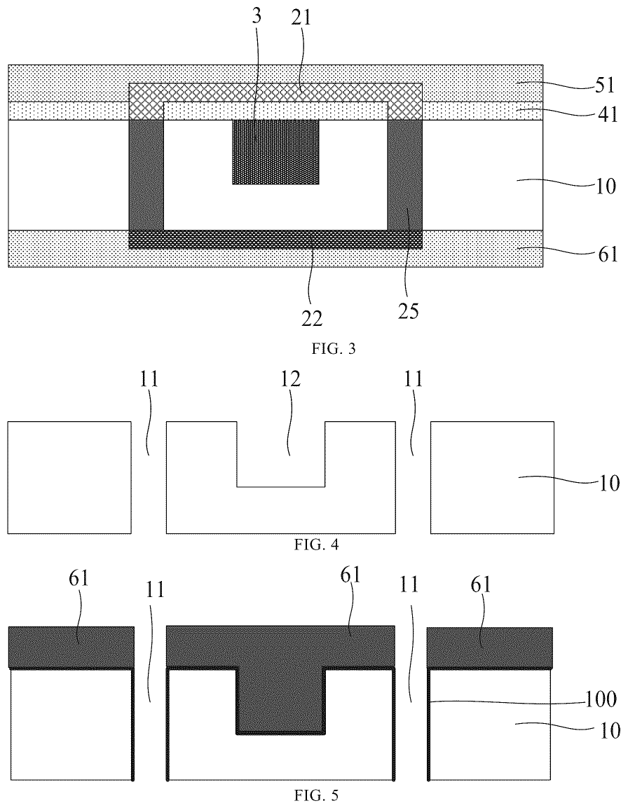

S11, providing a first dielectric substrate 10, and forming first connection vias 11 and a first groove 12 on the first dielectric substrate 10, as shown in FIG. 4.

In some embodiments, the first dielectric substrate 10 includes, but is not limited to, a glass substrate having a thickness in a range from about 0.2 mm to 2 mm.

Step S11 may specifically include: firstly, the first dielectric substrate 10 is cleaned, and ultrasonic cleaning is performed on the first dielectric substrate 10 through an organic solvent such as deionized water and ethanol, for example: the ultrasonic cleaning was performed in the solvents for 15 min, respectively. According to the design requirement for the inductor, the first connection vias 11 and the first groove 12 are formed by drilling and etching the groove at corresponding positions. A diameter of each first connection via 11 may be in a range from 50 μm to 1000 μm according to the thickness and design requirement for the first dielectric substrate 10; and the first connection vias 11 may be formed by using laser drilling, sand blasting drilling, or focused discharge drilling or the like according to a size of the via. A cross-sectional shape of the first groove 12 may be a square, a trapezoid, or a hourglass shape through the different etching processes. The first groove 12 has a length approximately equal to that of the inductor coil (i.e. the first connection vias 11 are divided into two groups arranged side by side, and a length of each group of the first connection vias 11 is also the length of the first groove 12) according to design requirements, so as to ensure that the magnetic core 3 may be located in the coil structure of the inductor, and a width of the first groove 12 is less than half of a distance between the two groups of the first connection vias, so as to ensure that there is a sufficient distance between the magnetic core 3 and the first connection electrodes 25. A depth of the first groove 12 may be in a range from 10 μm to 500 μm according to design.

S12, forming a first seed layer 100 covering sidewalls of the first connection vias 11 and the first groove 12, and shielding the first groove 12 by a first mask structure 61, as shown in FIG. 5.

In some embodiments, step S12 may include forming the first seed layer 100 within the first connection vias 11 and the first groove 12 by a process including, but not limited to, a sputtering process, and the first seed layer 100 may be made of a material selected from Ti, W, Cu, Mo, Ni, and the like. The first mask structure 61 is formed by spin coating, exposure, and development.

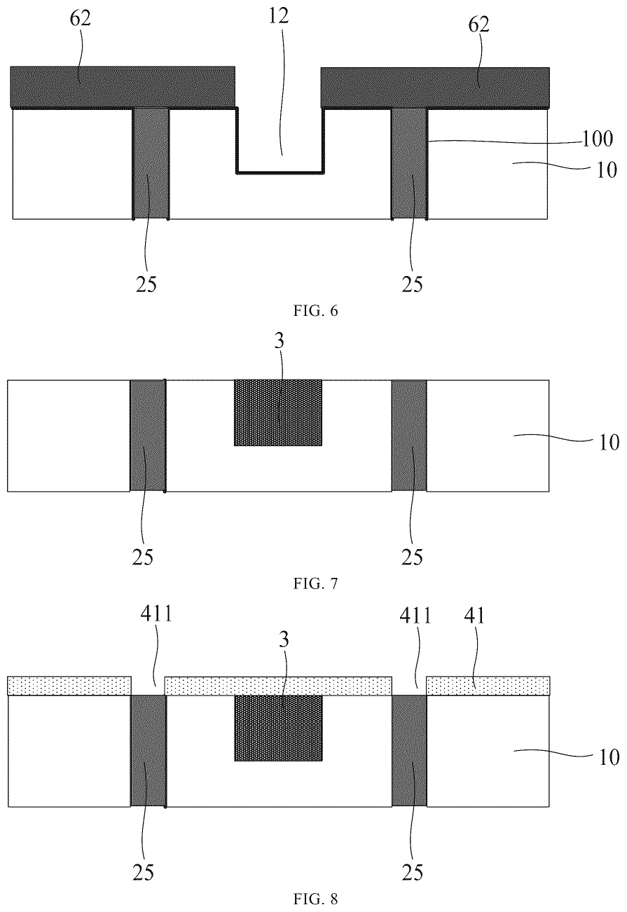

S13, electroplating the first seed layer 100 in the first connection vias 11 to form the first connection electrodes 25, and removing the first mask structure 61 to form a second mask structure 62 on the first connection vias 11, as shown in FIG. 6.

In some embodiments, each first connection electrode 25 is a component of the inductor, and is made of a metal with good conductivity, such as Cu, Au, Ag, or Al. The first connection vias 11 may be metallized by electroplating and chemical plating in step S13, so as to ensure that the formed first connection electrodes 25 may be electrically connected to the subsequently formed first and second sub-structures 21 and 22. The second mask structure 62 is formed by spin coating, exposure, and development.

S14, forming the magnetic core 3 located in the first groove 12, and removing the second mask structure 62, as shown in FIG. 7.

In some embodiments, a material of the magnetic core 3 in the first groove 12 may be a ferromagnetic material, and specifically, may be a high-permeability material such as Ni. Co, Fe, permalloy, ferrite, or the like, and chemical plating, PVD (physical vapor deposition), CVD (chemical vapor deposition), or the like may be used in step S14 according to the material of the magnetic core 3. The second mask structure 62 is removed after the magnetic core 3 is formed. It should be noted that because an excess structure is left on the first surface of the first dielectric substrate 10 in the processes of electroplating. PVD, etc., excess metal and material on the first surface of the first dielectric substrate 10 are removed by chemical mechanical polishing, and the metal in the first connection vias is ensured to be flat, so as to ensure that the electrical conduction between the first surface and the second surface of the first dielectric substrate 10 is realized by means of the metal in the first connection vias 11.

S15, forming a first interlayer insulating layer 41 on the first surface of the first dielectric substrate 10, and forming second connection vias penetrating through the first interlayer insulating layer 41, where the second connection vias are in one-to-one correspondence with the first connection vias 11, as shown in FIG. 8.

Since the material of the magnetic core 3 may be a conductor, in order to avoid the influence of the magnetic core 3 on the inductor, it is necessary to form the first interlayer insulating layer 41 on a surface of the magnetic core 3 and the first surface, to isolate the magnetic core 3 from the inductor. A material of the first interlayer insulating layer 41 may be an inorganic material such as silicon nitride, silicon oxide, etc., and a thickness of the first interlayer insulating layer 41 is in a range from 0.5 μm to 2 μm. The first interlayer insulating layer 41 may be formed by PVD or CVD, and then the second connection vias are formed by etching and developing. The first interlayer insulating layer 41 may also be made of an organic material, such as polyimide (PI) or other resin materials. In this case, the first interlayer insulating layer 41 may be patterned by processes such as spin coating, exposing and developing, and the like to form the second connection vias.

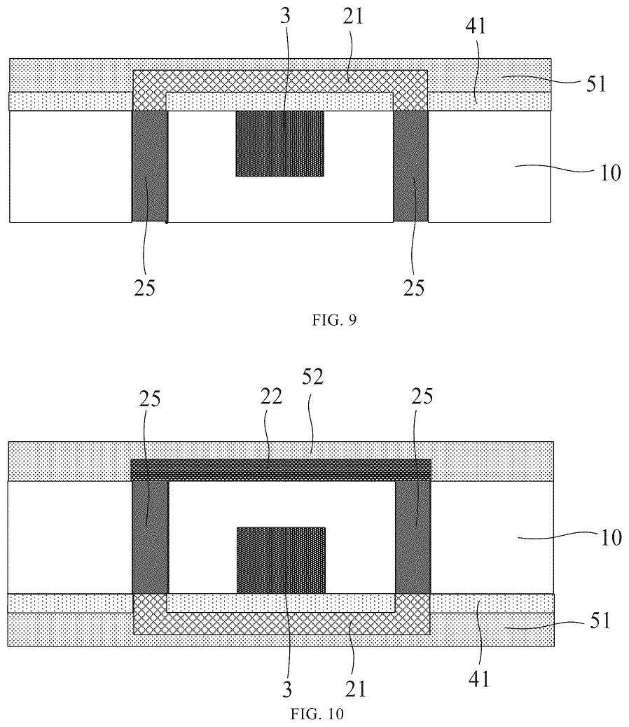

S16, forming a pattern including the first sub-structures 21 on a side of the first interlayer insulating layer 41 away from the first dielectric substrate 10 through a patterning process, and forming a first protective layer 51 on a surface of the first sub-structures 21 away from the first dielectric substrate 10, as shown in FIG. 9.

In some embodiments, step S16 may include forming a second seed layer by means including, but not limited to, sputtering; and then, forming the first sub-structures 21 of the inductor by spin coating a photoresist, exposing and developing, and electroplating the second seed layer. A material of the second seed layer is generally a metal material such as Au. Al, Cu, etc. A thickness of each first sub-structure 21 is typically in a range of 1 μm to 10 μm. In order to ensure the flatness of the first sub-structures 21 of the inductor, the surface of the first sub-structures 21 may be subsequently treated by chemical mechanical polishing.

The first protective layer 51 may be made of inorganic material, such as silicon nitride, silicon oxide, etc., and has a thickness in a range from 0.5 μm to 5 μm. At this time, the first protective layer 51 is formed by PVD or CVD. The first protection layer 51 may also be made of an organic material, such as polyimide (PI) or other resin material, and the first protective layer 51 is formed by a spin coating process.

S17, turning over the first dielectric substrate 10, forming the second sub-structures 22 on the second surface of the first dielectric substrate 10, and forming the second protective layer 52 on a surface of the second sub-structures 22 away from the first dielectric substrate 10, as shown in FIG. 10.

In some embodiments, step S17 may include forming a third seed layer by means including, but not limited to, sputtering; and then, forming the second sub-structures 22 of the inductor by spin coating a photoresist, exposing and developing, and electroplating the second third layer. A material of the third seed layer is generally a metal material such as Au, Al, Cu, etc. A thickness of each second sub-structure 22 is typically in a range of 1 μm to 10 μm. In order to ensure the flatness of the second sub-structures 22 of the inductor, the surface of the second sub-structures 22 may be subsequently treated by chemical mechanical polishing.

The second protective layer 52 may be made of inorganic material, such as silicon nitride, silicon oxide, etc., and has a thickness in a range from 0.5 μm to 5 μm. At this time, the second protective layer 52 is formed by PVD or CVD. The second protection layer 52 may also be made of an organic material, such as polyimide (PI) or other resin material, and the second protective layer 52 is formed by a spin coating process.

The preparation of the layers of the inductor in the first example is completed.

In a second example, FIG. 11 is a cross-sectional view of an inductor according to a second example of an embodiment of the present disclosure. As shown in FIG. 11, the inductor in this example is substantially the same in structure as the inductor in the first example, except that in this example, the magnetic core 3 does not completely fill the first groove 12. In this case, the first interlayer insulating layer 41 covering the magnetic core 3 is provided in the first groove 12. For example: a surface of the first interlayer insulating layer 41 covering the magnetic core 3 away from the second sub-structures 22 is flush with the first surface of the first dielectric substrate 10.

The inductor in the second example is manufactured in substantially the same way as the inductor in the first example, except that the magnetic core 3 is selectively partially filled when forming the magnetic core 3, which can save the material on the one hand and improve the process speed on the other hand. The patterned first interlayer insulating layer 41 only covers the magnetic core 3. The remaining steps may be the same as in the first example, and thus, the description will not be repeated here.

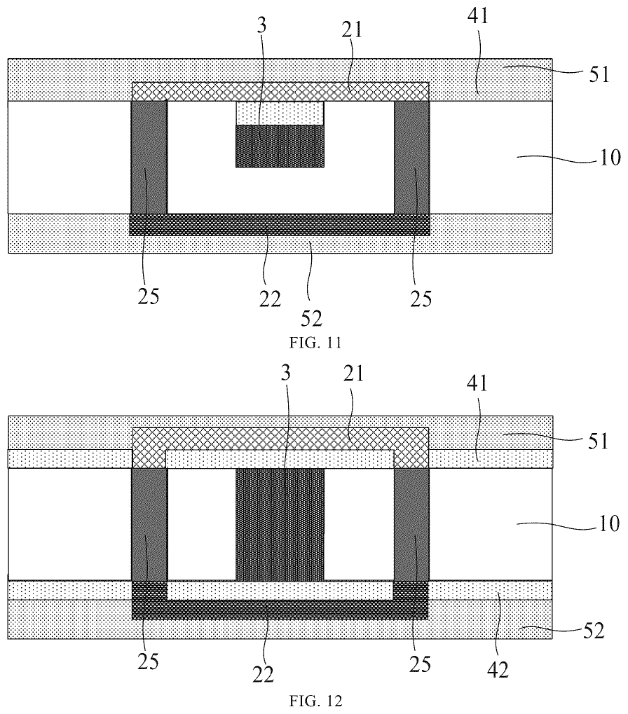

In a third example, FIG. 12 is a cross-sectional view of an inductor according to a third example of an embodiment of the present disclosure. As shown in FIG. 12, the inductor in this example is substantially the same in structure as the inductor in the first example, except that the first groove 12 in the first dielectric substrate 10 is a through groove, and the magnetic core 3 fills the first groove 12. A second interlayer insulating layer 42 is provided on the second surface; the second interlayer insulating layer 42 is provided with third connection vias therein in one-to-one correspondence with the first connection vias 11: the second sub-structures 22 are electrically connected to the first connection electrodes 25 through the third connection vias. The other structures of the inductor in this example are the same as those in the first example, and therefore, the description thereof will not be repeated.

The inductor in the third example is manufactured in substantially the same way as the inductor in the first example, except that the first groove 12 formed in the first dielectric substrate 10 is a through groove. Therefore, when forming the first connection electrodes 25 positioned in the first connection vias 11, it is necessary to form the first mask structures 61 blocking the first groove 12 on both the first surface and the second surface of the first dielectric substrate 10. It is also necessary to form the second interlayer insulating layer 42 and the third connection vias penetrating through the second interlayer insulating layer 42 before forming the second sub-structures 22. The second interlayer insulating layer 42 is formed by the same process as the first interlayer insulating layer 41, and thus, a description thereof will not be repeated. The manufacturing methods for the other structures of the inductor in the third example are substantially the same as those in the first example and thus will not be described repeatedly.

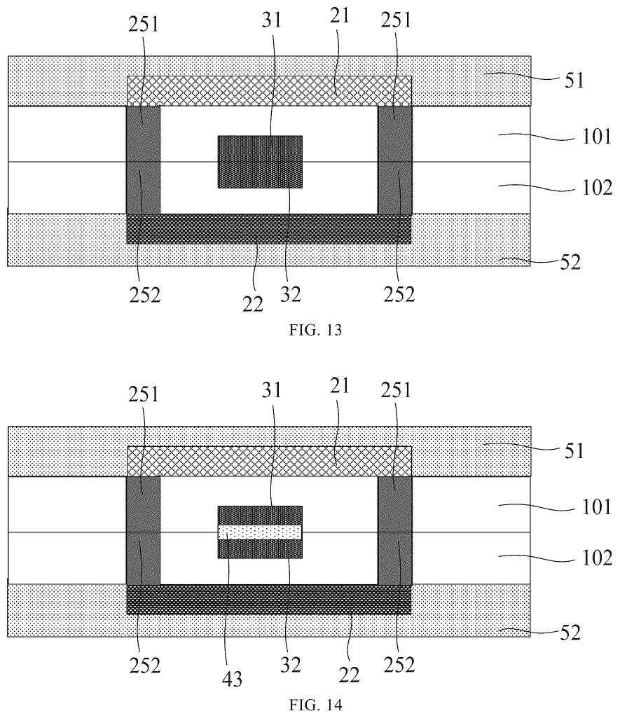

In a fourth example. FIG. 13 is a cross-sectional view of an inductor according to a fourth example of an embodiment of the present disclosure. As shown in FIG. 13, the inductor in this example are the same as that in the first example, and each include the first dielectric substrate 10, the first connection electrodes 25, the first sub-structures 21, and the second sub-structures 22, except that in this example, the first dielectric substrate 10 includes a first dielectric sub-substrate 101 and a second dielectric sub-substrate 102 which are stacked: a surface of the first dielectric sub-substrate 101 away from the second dielectric sub-substrate 102 serves as the first surface, and a surface of the second dielectric sub-substrate 102 away from the first dielectric sub-substrate 101 serves as the second surface. That is, the first sub-structures 21 are disposed on the surface of the first dielectric sub-substrate 101 away from the second dielectric sub-substrate 102: the second sub-structures 22 are disposed on the surface of the second dielectric sub-substrate 102 away from the first dielectric sub-substrate 101. The first connection vias 11 includes first connection sub-vias formed in the first dielectric sub-substrate 101, and second connection sub-vias in the second dielectric sub-substrate 102: the first groove 12 includes a first sub-groove formed in the first dielectric sub-substrate 101, and a second sub-groove formed in the second dielectric sub-substrate 102: the first sub-groove and the second sub-groove are both blind grooves, and an opening of the first sub-groove is opposite to and communicated with an opening of the second sub-groove: the magnetic core 3 includes a first portion 31 and a second portion 32, the first portion 31 fills the first sub-groove, the second portion 32 fills the second groove, and the first portion 31 and the second portion 32 are in contact with each other.

Furthermore, the first protective layer 51 is further disposed on a side of the first sub-structures 21 away from the first dielectric substrate 10, and the second protective layer 52 is further disposed on a side of the second sub-structures 22 away from the first dielectric substrate 10. The first protective layer 51 and the second protective layer 52 are respectively used to isolate the first sub-structures 21 and the second sub-structures 22 from external water and oxygen, thereby preventing the damage to the device.

The manufacturing method for the inductor in the fourth example adopts the same processes as in the manufacturing method in the first example. Specifically, in the fourth example, the first connection sub-vias and the second connection sub-vias may be formed in the same manner as the first connection vias 11 in the first example; the first and second sub-grooves may be formed in the same manner as the first groove 12 in the first example: first and second connection sub-electrodes 251 and 252 may be formed in the same manner as the first connection electrodes 25 in the first example: the first portion 31 and the second portion 32 of the magnetic core 3 may be formed in the same manner as the magnetic core 3 in the first example. The first sub-structures 21, the second sub-structures 22, the first protective layer 51 and the second protective layer 52 are formed in the same manner as in the first example. The process of forming layers in the embodiments of the present disclosure will not be described in detail.

It should be noted that after the layers on the first dielectric sub-substrate 101 and the layers on the second dielectric sub-substrate 102 of the inductor according to an embodiment of the present disclosure are formed, the first dielectric substrate 10 and the second dielectric sub-substrate 102 need to be integrated together by a bonding process to form a one-piece structure, so as to achieve the electrical connection between the first connection sub-electrodes 251 and the second connection sub-electrodes 252, thereby forming the inductor structure. The first dielectric sub-substrate 101 and the second dielectric sub-substrate 102 are combined together through a bonding process, so that the problem of stress in a single substrate can be effectively solved, the inductor with a larger cross-sectional area can be formed, the preparation of a large inductor is realized, and the difficulty of the drilling technology is reduced.

In a fifth example, FIG. 14 is a cross-sectional view of an inductor according to a fifth example of an embodiment of the present disclosure. As shown in FIG. 14, the inductor in this example is substantially the same in structure as the inductor in the fourth example, except that the first portion 31 of the magnetic core 3 does not completely fill the first sub-groove and the second portion 32 of the magnetic core 3 does not completely fill the second sub-groove. In this case, a third interlayer insulating layer 43 is provided between the first portion 31 and the second portion 32 of the magnetic core 3. The preparation and material selection of the third interlayer insulating layer 43 may be the same as those of the first interlayer insulating layer 41, and thus, the description will not be repeated here.

The structure of the inductor in the fifth example is substantially the same as that in the fourth example, and therefore the methods for manufacturing the inductor may be the same, and therefore, the description thereof is not repeated.

In a sixth example. FIG. 15 is a cross-sectional view of an inductor according to a sixth example of an embodiment of the present disclosure. As shown in FIG. 15, the inductor in this example is substantially the same as the inductor in the fourth example, except that both the first sub-groove and the second sub-groove are through grooves, and at this time, the first portion 31 of the magnetic core 3 fills the first sub-groove, and the second portion 32 fills the second sub-groove. In addition, the surface of the first dielectric sub-substrate 101 away from the second dielectric sub-substrate 102 serves as the first surface, and the surface of the second dielectric sub-substrate 102 away from the first dielectric sub-substrate 101 serves as the second surface: the first interlayer insulating layer 41 is provided on the first surface, and the second interlayer insulating layer 42 is provided on the second surface; the first interlayer insulating layer 41 is provided with second connection vias corresponding to the first connection vias 11 therein, and the second interlayer insulating layer 42 is provided with third connection vias corresponding to the first connection vias 11 therein; the first sub-structures 21 are electrically connected to the first connection electrodes 25 through the second connection vias: the second sub-structures 22 are electrically connected to the first connection electrodes 25 through the third connection vias.

The inductor in the sixth example is manufactured in substantially the same manner as in the fourth example, except that the first sub-groove and the second sub-groove are through grooves. The first interlayer insulating layer 41 is formed on a side of the first dielectric sub-substrate 101 away from the second dielectric sub-substrate 102, and the second interlayer insulating layer 42 is formed on a side of the second dielectric sub-substrate away from the first dielectric sub-substrate 101; the second connection vias corresponding to the first connection vias 11 are formed in the first interlayer insulating layer 41, and the third connection vias corresponding to the first connection vias 11 are formed in the second interlayer insulating layer 42; the first sub-structures 21 are electrically connected to the first connection electrodes 25 through the second connection vias: the second sub-structures 22 are electrically connected to the first connection electrodes 25 through the third connection vias. The processes of forming the first interlayer insulating layer 41 and the second interlayer insulating layer 42 are the same as those in the third example, and thus the description is not repeated here.

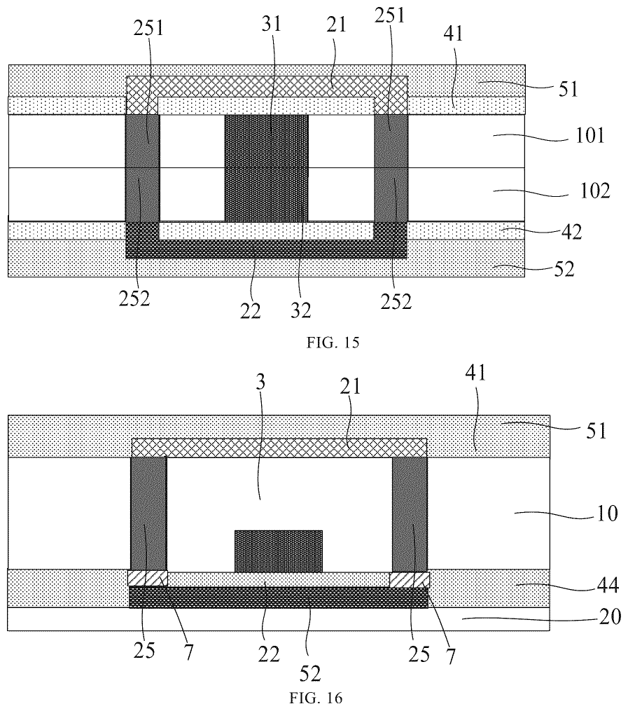

In a seventh example. FIG. 16 is a cross-sectional view of an inductor according to a seventh example of an embodiment of the present disclosure. As shown in FIG. 16, the inductor in this example is substantially the same in structure as the inductor in the first example, except that the inductor includes a second dielectric substrate 20 on which the second sub-structures 22 are disposed, a fourth interlayer insulating layer 44 is disposed on a side of the second sub-structures 22 away from the second dielectric substrate 20, fourth connection vias corresponding to the first connection vias 11 are disposed in the fourth interlayer insulating layer 44, and the second sub-structures 22 are electrically connected to the first connection electrodes 25 through adapter electrodes 7 located in the fourth connection vias. In this structure, the second sub-structures 22 of the inductor may be formed on the second dielectric substrate 20, which effectively reduces the difficulty of the process, improves the accuracy of the patterning, and reduces the film stress of the substrate. After the structures on the first dielectric substrate 10 and the second dielectric substrate 20 is formed and the first dielectric substrate 10 and the second dielectric substrate 20 are bonded together to form the inductor structure.

The processes for forming the structures on the first dielectric substrate 10 in this example may be the same as those in the fourth example, and therefore, the description thereof is not repeated here.

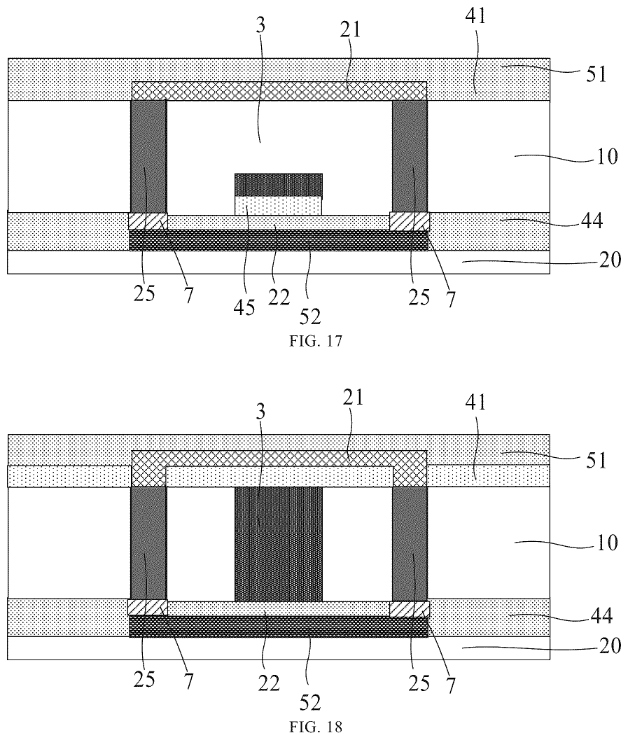

In an eighth example, FIG. 17 is a cross-sectional view of an inductor according to an eighth example of an embodiment of the present disclosure. As shown in FIG. 17, the inductor in this example is substantially the same in structure as the inductor in the seventh example, except that the magnetic core 3 does not completely fill the first groove 12; a fifth interlayer insulating layer 45 is further provided in the first groove 12 between the magnetic core 3 and the fourth interlayer insulating layer 44, and the remaining structure is the same as that in the seventh example, and therefore, the description thereof is not repeated.

The method for manufacturing the inductor in the eighth example is substantially the same as that in the seventh example, except that the fifth interlayer insulating layer in the first groove 12 needs to be formed in the eighth example, and the preparation and material of the fifth interlayer insulating layer 45 are the same as those of the first interlayer insulating layer 41 in the second example, and thus, the description thereof is not repeated here.

In a ninth example, FIG. 18 is a cross-sectional view of an inductor according to a ninth example of an embodiment of the present disclosure. As shown in FIG. 18, the inductor in this example is substantially the same in structure as the inductor in the seventh example, except that in this example, the first groove 12 is a through groove, the magnetic core 3 fills the first groove 12, and the first interlayer insulating layer 41 is provided on the first surface of the first dielectric substrate 10; the first interlayer insulating layer 41 is provided with second connection vias therein in one-to-one correspondence with the first connection vias 11: the first sub-structures 21 are electrically connected to the first connection electrodes 25 through the second connection vias. After the structures on the first dielectric substrate 10 and the second dielectric substrate 20 is formed and the first dielectric substrate 10 and the second dielectric substrate 20 are bonded together to form the inductor structure.

The processes for forming the structures on the first dielectric substrate 10 in this example may be the same as those in the fifth example, and therefore, the description thereof is not repeated here.

It should be noted that the inductor and the method for manufacturing an inductor in the examples are only given above, but which is not to be construed as limiting the scope of the embodiments of the present disclosure, as long as the inductor where the magnetic core 3 is integrated in the first dielectric substrate 10 is within the scope of the embodiments of the present disclosure.

An embodiment of the present disclosure further provides a filter, which includes the inductor any one of the above embodiments. Alternatively, the filter may further include a capacitor electrically connected to the inductor to form an LC filter.

The magnetic core 3 with the permeability of much greater than 1000 is provided in the coil structure of the inductor in the embodiment of the present disclosure, so that the inductance value per unit area is improved, and the wider use of devices and the miniaturization application of packaging are facilitated.

In some embodiments, a first plate of the capacitor and the first sub-structures of the inductor may be connected together to form a one-piece structure, that is, the first plate of the capacitor is formed while the first sub-structures of the inductor are formed, which does not increase the process cost.

It should be noted that in the filter in the embodiment of the present disclosure, one or more capacitors and one or more inductors may be included, and the number of the capacitors and the inductors in the filter is not limited herein. Alternatively, a resistor or the like may be provided in the filter, which is not illustrated.

The embodiment of the present disclosure provides an electronic device, which includes the above filter, and the electronic device may be a mobile terminal, a notebook computer, or the like.

It should be understood that the above embodiments are merely exemplary embodiments adopted to explain the principles of the present disclosure, and the present disclosure is not limited thereto. It will be apparent to one of ordinary skill in the art that various changes and modifications may be made therein without departing from the spirit and scope of the present disclosure, and such changes and modifications also fall within the scope of the present disclosure.

1. An inductor, comprising:
a first dielectric substrate comprising a first surface and a second surface opposite to each other along a thickness direction of the first dielectric substrate, wherein the first dielectric substrate is provided with first connection vias penetrating through the first dielectric substrate along the thickness direction of the first dielectric substrate, and a first groove penetrating through a part of the first dielectric substrate in the thickness direction of the first dielectric substrate;
first sub-structures on the first surface;
second sub-structures on the second surface;
first connection electrodes in the first connection vias, wherein the first sub-structures and the second sub-structures are sequentially connected together through the first connection electrodes to form a coil structure of the inductor; and
a magnetic core arranged in the first groove and insulated from the first sub-structures and the second sub-structures to be in the coil structure.

2. The inductor according to claim 1, wherein the first groove is a blind groove, the magnetic core fills the first groove, a first interlayer insulating layer is provided on the first surface, the first interlayer insulating layer is provided with second connection vias, corresponding to the first connection vias, therein, and the first sub-structures are electrically connected to the first connection electrodes through the second connection vias, respectively.

3. The inductor according to claim 1, wherein the first groove is a blind groove, a surface of the magnetic core away from the second sub-structures is spaced apart from the first surface, and a first interlayer insulating layer is provided in the first groove and covers the surface of the magnetic core away from the second sub-structures.

4. The inductor according to claim 3, wherein a surface of the first interlayer insulating layer away from the magnetic core is flush with the first surface.

5. The inductor according to claim 1, wherein the first groove is a through groove, the magnetic core fills the first groove; a first interlayer insulating layer is provided on the first surface, and a second interlayer insulating layer is provided on the second surface; the first interlayer insulating layer is provided with second connection vias, corresponding to the first connection vias, therein, and the second interlayer insulating layer is provided with third connection vias, corresponding to the first connection vias, therein; the first sub-structures are electrically connected to the first connection electrodes through the second connection vias, respectively; and the second sub-structures are electrically connected to the first connection electrodes through the third connection vias, respectively.

6. The inductor according to claim 1, wherein the first dielectric substrate comprises a first dielectric sub-substrate and a second dielectric sub-substrate which are stacked together; a surface of the first dielectric sub-substrate away from the second dielectric sub-substrate is the first surface, and a surface of the second dielectric sub-substrate away from the first dielectric sub-substrate is the second surface; and
the first connection vias comprise first connection sub-vias in the first dielectric sub-substrate and second connection sub-vias in the second dielectric sub-substrate; the first groove comprises a first sub-groove in the first dielectric sub-substrate and a second sub-groove in the second dielectric sub-substrate; the first sub-groove and the second sub-groove are both blind grooves, and an opening of the first sub-groove is opposite to and communicated with an opening of the second sub-groove; the magnetic core comprises a first portion filling the first sub-groove and a second portion filling the second sub-groove, and the first portion and the second portion are in contact with each other.

7. The inductor according to claim 1, wherein the first dielectric substrate comprises a first dielectric sub-substrate and a second dielectric sub-substrate which are stacked together; a surface of the first dielectric sub-substrate away from the second dielectric sub-substrate is the first surface, and a surface of the second dielectric sub-substrate away from the first dielectric sub-substrate is the second surface; and
the first connection vias comprise first connection sub-vias in the first dielectric sub-substrate and second connection sub-vias in the second dielectric sub-substrate, respectively; the first groove comprises a first sub-groove in the first dielectric sub-substrate and a second sub-groove in the second dielectric sub-substrate; the first sub-groove and the second sub-groove are both blind grooves, and an opening of the first sub-groove is opposite to and communicated with an opening of the second sub-groove; the magnetic core comprises a first portion in the first sub-groove and a second portion in the second sub-groove, and a third interlayer insulating layer is provided between the first portion and the second portion.

8. The inductor according to claim 1, wherein the first dielectric substrate comprises a first dielectric sub-substrate and a second dielectric sub-substrate which are stacked together; the first connection vias comprise first connection sub-vias in the first dielectric sub-substrate and second connection sub-vias in the second dielectric sub-substrate, respectively; the first groove comprises a first sub-groove in the first dielectric sub-substrate and a second sub-groove in the second dielectric sub-substrate; the first sub-groove and the second sub-groove are both through grooves, and the first sub-groove and the second sub-groove are opposite to and communicated with each other; the magnetic core comprises a first portion filling the first sub-groove and a second portion filling the second sub-groove, and the first portion and the second portion are in contact with each other;
a surface of the first dielectric sub-substrate away from the second dielectric sub-substrate is the first surface, and a surface of the second dielectric sub-substrate away from the first dielectric sub-substrate is the second surface; and
a first interlayer insulating layer is provided on the first surface, and a second interlayer insulating layer is provided on the second surface; the first interlayer insulating layer is provided with second connection vias, corresponding to the first connection vias, therein, and the second interlayer insulating layer is provided with third connection vias, corresponding to the first connection vias, therein; the first sub-structures are electrically connected to the first connection electrodes through the second connection vias, respectively; the second sub-structures are electrically connected to the first connection electrodes through the third connection vias, respectively.

9-10. (canceled)

11. The inductor according to claim 1, wherein the first groove is a blind groove and an opening of the first groove is away from the first sub-structures; the inductor further comprises a second dielectric substrate; the second sub-structures are on the second dielectric substrate, a fourth interlayer insulating layer is provided on a side of the second sub-structures away from the second dielectric substrate, fourth connection vias are provided in the fourth interlayer insulating layer and correspond to the first connection vias, respectively, and the second sub-structures are electrically connected to the first connection electrodes through the fourth connection vias, respectively.

12. The inductor according to claim 1, wherein the first groove is a blind groove and an opening of the first groove is away from the first sub-structures; the inductor further comprises a second dielectric substrate; the second sub-structures are on the second dielectric substrate, a fourth interlayer insulating layer is provided on a side of the second sub-structures away from the second dielectric substrate, fourth connection vias are provided in the fourth interlayer insulating layer and correspond to the first connection vias, respectively, and the second sub-structures are electrically connected to the first connection electrodes through the fourth connection vias, respectively; and
a fifth insulating layer is provided in the first groove and on a side of the magnetic core away from the first sub-structures; and a surface of the fifth insulating layer away from the magnetic core is flush with the second surface.

13. The inductor according to claim 1, wherein the first groove is a through groove, the magnetic core fills the first groove; a first interlayer insulating layer is provided on the first surface; the first interlayer insulating layer is provided with second connection vias, corresponding to the first connection vias, therein; and the first sub-structures are electrically connected to the first connection electrodes through the second connection vias, respectively; and
the inductor further comprises a second dielectric substrate; the second sub-structures are on the second dielectric substrate, a fourth interlayer insulating layer is provided on a side of the second sub-structures away from the second dielectric substrate, fourth connection vias are provided in the fourth interlayer insulating layer and corresponds to the first connection vias, respectively, and the second sub-structures are electrically connected to the first connection electrodes through the fourth connection vias, respectively.

14. The inductor according to claim 11, wherein adapter electrodes are provided within the fourth connection vias, respectively, and the second sub-structures are electrically connected to the first connection electrodes through the adapter electrodes, respectively.

15. (canceled)

16. A method for manufacturing an inductor, comprising:
providing a first dielectric substrate, wherein the first dielectric substrate comprises a first surface and a second surface opposite to each other along a thickness direction of the first dielectric substrate, the first dielectric substrate is provided with first connection vias penetrating through the first dielectric substrate along the thickness direction of the first dielectric substrate, and a first groove penetrating through a part of the first dielectric substrate in the thickness direction of the first dielectric substrate; and
forming first sub-structures on the first surface; forming second sub-structures on the second surface; forming first connection electrodes in the first connection vias, forming a magnetic core in the first groove; wherein the first sub-structures and the second sub-structures are sequentially connected together through the first connection electrodes to form a coil structure of the inductor; and the magnetic core is insulated from the first sub-structures and the second sub-structures to be in the coil structure.

17. The method for manufacturing an inductor according to claim 16, wherein the first groove is a blind groove, and an opening of the first groove is opposite to the first sub-structures; before the forming the first sub-structures on the first surface, the method further comprises:
forming a first interlayer insulating layer on the first surface, to insulate the magnetic core from the first sub-structures.

18. The method for manufacturing an inductor according to claim 16, wherein the first groove is a through groove; before the forming the first sub-structures on the first surface, the method further comprises:
forming a first interlayer insulating layer on the first surface, to insulate the magnetic core from the first sub-structures; and
after the forming the second sub-structures on the second surface, the method further comprises:
forming a second interlayer insulating layer on the second surface, to insulate the magnetic core and the second sub-structures.

19. The method for manufacturing an inductor according to claim 16, wherein the first dielectric substrate comprises a first dielectric sub-substrate and a second dielectric sub-substrate which are stacked together; the first connection vias comprise first connection sub-vias formed in the first dielectric sub-substrate and second connection sub-vias formed in the second dielectric sub-substrate; the first groove comprises a first sub-groove formed in the first dielectric sub-substrate and a second sub-groove formed in the second dielectric sub-substrate; the first sub-groove and the second sub-groove are both blind grooves, and the first sub-groove and the second sub-groove are opposite to and communicated with each other; a surface of the first dielectric sub-substrate away from the second dielectric sub-substrate is the first surface, and a surface of the second dielectric sub-substrate away from the first dielectric sub-substrate is the second surface;
the forming the magnetic core comprises:
forming a first portion of the magnetic core in the first sub-groove to fill the first sub-groove, and forming a second portion of the magnetic core in the second sub-groove; and
the method further comprises:
forming a third insulating layer between the first portion and the second portion.

20. The method for manufacturing an inductor according to claim 16, wherein the first dielectric substrate comprises a first dielectric sub-substrate and a second dielectric sub-substrate which are stacked together; the first connection vias comprise first connection sub-vias formed in the first dielectric sub-substrate and second connection sub-vias formed in the second dielectric sub-substrate; the first groove comprises a first sub-groove formed in the first dielectric sub-substrate and a second sub-groove formed in the second dielectric sub-substrate; the first sub-groove and the second sub-groove are both through grooves, and the first sub-groove and the second sub-groove are opposite to and communicated with each other; a surface of the first dielectric sub-substrate away from the second dielectric sub-substrate is the first surface, and a surface of the second dielectric sub-substrate away from the first dielectric sub-substrate is the second surface;
the forming the magnetic core comprises:
forming a first portion of the magnetic core in the first sub-groove to fill the first sub-groove, and forming a second portion of the magnetic core in the second sub-groove, wherein the first portion and the second portion are in contact with each other;
after the forming the first sub-structures, the method further comprises:
forming a first interlayer insulating layer on the first surface, to insulate the magnetic core from the first sub-structures; and
after the forming the second sub-structures on the second surface, the method further comprises:
forming a second interlayer insulating layer on the second surface, to insulate the magnetic core and the second sub-structures.

21. A filter, comprising an inductor, which comprises:
a first dielectric substrate comprising a first surface and a second surface opposite to each other along a thickness direction of the first dielectric substrate, wherein the first dielectric substrate is provided with first connection vias penetrating through the first dielectric substrate along the thickness direction of the first dielectric substrate, and a first groove penetrating through a part of the first dielectric substrate in the thickness direction of the first dielectric substrate;
first sub-structures on the first surface;
second sub-structures on the second surface;
first connection electrodes in the first connection vias, wherein the first sub-structures and the second sub-structures are sequentially connected together through the first connection electrodes to form a coil structure of the inductor; and
a magnetic core arranged in the first groove and insulated from the first sub-structures and the second sub-structures to be in the coil structure.

22. The filter according to claim 21, further comprising a capacitor electrically connected to the inductor, wherein a first plate of the capacitor and the first sub-structures of the inductor are connected together to form a one-piece structure.

23. An electronic device, comprising the filter according to claim 21.
